(19) United States
(12) Patent Application Publication
(10) Pub. No.: US 2025/0212934 A1
(43) Pub. Date: Jul. 3, 2025

(54) AEROSOL-GENERATING COMPOSITIONS AND USES THEREOF

(71) Applicant: NICOVENTURES TRADING LIMITED, London (GB)

(72) Inventors: John RICHARDSON, London (GB); Robert PRESS, London (GB)

(21) Appl. No.: 18/852,743

(22) PCT Filed: Mar. 31, 2023
(86) PCT No.: PCT/GB2023/050865

§ 371 Date: Sep. 30, 2024

(30) Foreign Application Priority Data
Apr. 1, 2022 (GB) 2204842.5

(51) Int. Cl. A24B 15/10; A24B 15/28; A24B 15/32; A24B 15/40; A24D 1/20; A24F 40/20; A24F 40/465; B41M 3/00; H05B 6/10

(52) U.S. Cl. CPC A24B 15/10; A24B 15/285; A24B 15/32; A24B 15/403; A24D 1/20; A24F 40/20; A24F 40/465; B41M 3/006; H05B 6/108

(57) ABSTRACT

The invention relates to aerosol-generating compositions for printing, the compositions comprising a solid aerosol-generating material comprising a dried extract from a flavour-and/or active-containing plant material, wherein the solid aerosol-generating material is suspended or dissolved in a liquid component. The aerosol-generating composition may be applied to a support to form a substrate. The aerosol-generating composition may be used to generate an aerosol. For example, the aerosol-generating composition may be used in non-combustible aerosol-provision systems. The invention also relates to aerosol-provision systems comprising the aerosol-generating composition, and methods of providing the aerosol-generating composition.

### FIELD

The invention relates to aerosol-generating compositions, methods of manufacturing the suspensions and uses thereof.

### BACKGROUND

Aerosol-generating materials for use in a combustible or a non-combustible aerosol provision system may include a variety of different active substances and/or flavours.

Factors such as the concentration of volatile active and/or flavour components in the aerosol generating materials and the stability of the aerosol-generating materials will influence the properties of the aerosol generated.

### SUMMARY

According to a first aspect of the present invention, there is provided an aerosol-generating composition for printing, the composition comprising a solid aerosol-generating material comprising a dried extract from a flavour-and/or active-containing plant material and an aerosol-former material, wherein the solid aerosol-generating material is suspended or dissolved in a liquid component.

In some embodiments, the liquid component comprises a solvent that evaporates to produce a dried aerosol-generating composition.

In some embodiments, the solvent is one or more selected from the group consisting of: water; hydrocarbons; aromatic compounds; monohydric alcohols; polyhydric alcohols; ketones; esters; and ethers.

In some embodiments, the liquid component comprises the solvent in an amount of from about 1 to about 50% by volume of the total liquid component.

In some embodiments, wherein the liquid component comprises a binder. In some embodiments, the binder is one or more selected from the group consisting of: gelatin; starches; polysaccharides; pectins; celluloses; cellulose derivatives; and alginates.

In some embodiments, the liquid component comprises the binder in an amount of from about 1 to about 50 wt % by weight of the total liquid component.

In some embodiments, the composition comprising from about 10 to about 50 wt % solid aerosol-generating material based on the total weight of the composition.

In some embodiments, the aerosol-former material is selected from the group consisting of: glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the solid aerosol-generating material is formed by drying a precursor composition comprising an extract from a flavour- and/or active-containing plant material.

In some embodiments, the precursor material is dried to a moisture content of from o to about 5% (calculated on a wet weight basis).

In some embodiments, the precursor material comprises from about 10 to 95% by weight of the extract from a flavour-or active-containing plant material.

In some embodiments, the precursor composition comprises one or more aerosol-former material.

In some embodiments, the precursor material comprises from about 1 to about 36 wt % aerosol-former material.

In some embodiments, the precursor material comprises from o to about 40% by weight of an excipient.

In some embodiments, the excipient is one or more selected from the group consisting of include mannitol, sucrose, trehalose, lactose, sorbitol, raffinose, maltose, Dextran 10, Dextran 70, Dextran 90, maltodextrin, gelatin, agar, cyclodextrin, PEG 2000-6000, and PVP 10.

In some embodiments, the precursor material comprises a liquid suspension comprising particles with an average particle size of no greater than about 1 mm, when measured by sieving.

In some embodiments, the plant material is selected from the group consisting of tobacco, eucalyptus, star anise, cocoa and hemp.

In some embodiments, the extract from a flavour- or active-containing plant material is an aqueous extract.

In some embodiments, the extract from a flavour- or active-containing plant material is an aqueous tobacco extract.

In some embodiments, the solid aerosol-generating material comprises from about 40 to about 99% by weight tobacco solids.

In some embodiments, the solid aerosol-generating material is in the form of particles with a maximum particle size of about 1 mm, when measured by sieving

According to a second aspect of the present invention there is provided a substrate for use in a non-combustible aerosol-provision system, comprising an aerosol-generating composition according to the first aspect, printed on a support.

In some embodiments, the support comprises one or more selected from the group consisting of: paper, card, paperboard, cardboard, reconstituted material, a plastics material, activated carbon, glass, a sintered material, a ceramic material, a composite material, a plant-derived material, a fabric or fleece, a fibrous tow, a metal, and a metal alloy.

In some embodiments, the support comprises a heating material.

In some embodiments, the aerosol-generating composition covers at least a portion of a surface of the support.

In some embodiments, a plurality of discrete portions of the aerosol-generating composition are provided on the support.

According to a third aspect of the invention there is provided an aerosol-generating composition according to the first aspect, or a substrate according to the second aspect, for use in an aerosol provision system.

According to a fourth aspect of the invention there is provided an article comprising a composition comprising an extract from a flavour- and/or active-containing plant material and an aerosol-former material printed on a support.

In some embodiments, the article comprises a substrate according to the second aspect.

According to a fifth aspect of the present invention there is provided a non-combustible aerosol-provision system comprising an aerosol-generating composition according to the first aspect or a substrate according to the second aspect.

According to a sixth aspect of the present invention, there is provided a method of providing an aerosol-generating composition for printing comprising: drying a precursor material comprising an extract from a flavour- and/or active-containing plant material to form a solid aerosol-generating material; and suspending or dissolving the solid aerosol-generating material in a liquid component.

In some embodiments, the method further comprises adjusting the particle size of the solid aerosol-generating material to a maximum size of about 1 mm, when measured by sieving.

In some embodiments, the method further comprises adjusting the particle size of any solid material in the precursor material to a maximum size of about 1 mm, when measured by sieving.

In some embodiments, the precursor material is dried by spray-drying or freeze-drying.

According to a seventh aspect of the present invention, there is provided a method for providing a substrate comprising: contacting a support with an aerosol-generating composition according to the first aspect; and drying the aerosol-generating composition to form a coating of an aerosol generating material on the support.

In some embodiments, the aerosol-generating composition is applied by a printing process. In some embodiments, the printing process is selected from the group consisting of: gravure printing, screen printing, lithography, relief printing and digital printing.

### BRIEF DESCRIPTION OF THE DRAWINGS

Embodiments of the invention will now be described, by way of example only, with reference to accompanying drawings, in which:

FIG. 1 is a schematic illustration of a substrate as described herein.

FIG. 2 is a schematic illustration of another substrate as described herein.

FIG. 3 is a schematic illustration of another substrate comprising a composition as described herein.

FIG. 4 is a side-on cross-sectional view of a first embodiment of a consumable comprising a substrate as described herein; and

FIG. 5 is a perspective illustration of a non-combustible aerosol provision device for generating aerosol from the composition of the consumable shown in FIG. 4.

### DETAILED DESCRIPTION

An aerosol-generating material is a material that is capable of generating aerosol, for example when heated, irradiated or energized in any other way.

Conventional aerosol-generating materials which comprise tobacco material or a tobacco extract may be used in combustible and non-combustible aerosol-generating devices, including hybrid devices and tobacco heating products, to provide the user with an aerosol with an authentic tobacco taste and texture. One issue encountered with such materials is that the content of the flavour, other volatile compound(s) and nicotine decreases with storage of the aerosol-generating material, dropping off particularly towards the end of the life of the material. This is because the more volatile components, including nicotine and many flavours and aromas, are readily released from the material. Additionally, as the moisture content of the aerosol-generating material increases through moisture absorption, the release of substances such as nicotine and flavours is negatively impacted. Aerosol-generating materials that are produced using conventional methods and procedures commonly need to be used within one to three days of production. There is therefore a need to improve the shelf life of the aerosol generating material.

A further issue associated with conventional aerosol-generating materials comprising tobacco material or a tobacco extract is that the concentration of the desired components such as nicotine and flavours is relatively low. This limits the concentration of these desired components in the aerosol generated. Additionally, this means that a relatively large amount of the aerosol-generating material is needed and, accordingly, high amounts of energy are required to heat the aerosol-generating material in order to release the desired components.

The present invention relates to aerosol-generating compositions that can be printed.

These compositions provide the aerosol-generating composition in a form that allows it to be applied to a substrate in a precise and accurate manner. This is particularly advantageous as the compositions includes high concentrations of flavour and/or active and so very small amounts can provide an aerosol with desirable properties. The compositions that are capable of being printed may also be referred to as “inks” herein.

The present invention addresses some of the most significant short-comings of conventional vapour systems, namely the provision of an aerosol that provides an authentic tobacco taste. Attempts have been made in the past to utilise liquid tobacco extracts in the e-liquids for vapour systems. However, these extracts tend to be very dilute when added to the other liquid components and so fail to provide the tobacco flavours in adequate amounts. There can also be issues with the stability of the liquid formulation as a result of the relatively high water content that can cause instability and shorten the shelf-life of the product. In contrast, the present invention provides the tobacco or other plant extract in an extremely concentrated form, which can provide a strong and authentic tobacco taste to the vaping experience. The taste experience is more authentic as the aerosol-generating compositions includes the wide range and complex blend of flavours from the plant, as well as providing these in concentrated form to ensure that these flavours may be perceived in the aerosol generated by the vapour system.

The printable aerosol-generating compositions comprise a solid aerosol-generating material suspended or dissolved in a liquid component.

The solid aerosol-generating material is a dried or dehydrated aerosol generating material formed from an extract from a flavour- and/or active-containing plant material. In some embodiments, the extract is a liquid solution or suspension and it may be dried or dehydrated using a process such as spray-drying or freeze-drying. The dried or dehydrated aerosol generating material may be formed from a precursor material comprising the extract from a flavour- and/or active-containing plant material and an aerosol-former material.

The liquid component gives the aerosol-generating compositions suitable properties that enable it to be printed. The solid aerosol-generating material is suspended or dissolved in the liquid component to form the printable aerosol-generating compositions.

The aerosol-generating compositions have a viscous form, which allows them to be printed. Once printed, the compositions may dry. Both in the viscous and dried forms, the aerosol-generating compositions may be heated to form an aerosol.

The aerosol-generating compositions comprise the dried extract from a flavour- and/or active-containing plant material which comprises a high concentration of the flavour and/or active, with little or no material that does not contribute to the aerosol generated from the dried aerosol-generating material. As such, small amounts of the aerosol-generating composition are sufficient to generate aerosol with desired active and flavour content. Further, the aerosol may be generated with the input of relatively low levels of energy.

An additional benefit of the aerosol-generating compositions of is that the low water content reduces issues associated with “hot puff”, which are known in the art.

In some embodiments, the dried aerosol-generating material has a moisture content of from o to about 10%, or from o to about 5% (calculated on a wet weight basis), as measured by gas chromatography-thermal conductivity detector (GC-TCD) or Karl Fischer titration. In some embodiments, the moisture content of the dried aerosol-generating material is less than about 3 wt %, for example from about o to about 3 wt %, or from about 0.5 to about 2.5 wt %.

Karl Fischer titration is a classic method of chemical analysis for reliably determining the amount of water in a sample, and even just trace amounts. The method can be readily carried out using an automated Karl Fischer titrator. Similarly, the use of GC-TCD is also a well-established method for reliably determining the water content in a sample.

Unless stated otherwise, references to moisture content herein are references to the moisture content as measured by Karl Fischer.

### The Solid Aerosol-Generating Material

The solid aerosol-generating material included in the aerosol-generating compositions of the present invention comprises a dried extract from a flavour- and/or active-containing plant material.

In some embodiments, the solid aerosol-generating material is formed by drying a precursor material comprising an extract from a flavour- and/or active-containing plant material. The drying process is selected to retain the desired components of the precursor material and, therefore, the solid aerosol-generating material may comprise one or more active substances and/or flavours.

In some embodiments, the extract from a flavour- or active-substance containing plant material is an extract derived by contacting the plant material with a suitable solvent, such as an aqueous solvent or an alcohol such as ethanol. The liquid portion comprising the solvent and any dissolved plant components may then be separated or partially separated from the remaining solid plant material to provide the extract to be included in the precursor composition and dried.

The precursor material and/or the solid aerosol-generating material may also optionally include one or more other functional materials.

The invention enjoys the advantage of a solid aerosol-generating material that is formulated to have an increased shelf life and so it may be easily transported and stored. Without wishing to be bound by any particular theory, it is hypothesised that the low water content of the solid aerosol-generating material reduces evaporation over time of other solvents, and reduces degradation of nicotine and/or other volatile compounds. A low water content also inhibits microbial growth.

The solid aerosol-generating materials and the aerosol-generating compositions, including, for example, suspensions comprising the dried extract from a flavour- and/or active-containing plant material described herein are stable at a range of temperatures and humidities and have an increased shelf-life, and are therefore easy to store and transport. In some embodiments, the compositions may be stored at temperatures in the range of 0-35° C. In some embodiments, the compositions may be stored at a relative humidity of up to about 30%, or up to 50% or even up to 90%, prior to use.

The solid aerosol-generating materials also have the advantage of having a high concentration of the desired components. This means that relatively small amounts of the solid aerosol-generating material are required and less energy is required to heat and release the desired components. Significantly, the aerosols generated from these materials also provide an authentic tobacco taste of reasonable strength.

In some embodiments, the extract from a flavour- or active-substance containing plant material is an extract derived from tobacco material.

The tobacco extract or material may be from or may be any type of tobacco and any part of the tobacco plant, including tobacco lamina, stem, stalk, ribs, scraps and shorts or mixtures of two or more thereof. Suitable tobacco extracts or materials include the following types: Virginia or flue-cured tobacco, Burley tobacco, Oriental tobacco, or blends of tobacco materials, optionally including those listed here. The tobacco may be expanded, such as dry-ice expanded tobacco (DIET), or processed by any other means. In some embodiments, the tobacco material may be reconstituted tobacco material. The tobacco may be pre-processed or unprocessed, and may be, for instance, solid stems (SS); shredded dried stems (SDS); steam treated stems (STS); or any combination thereof. The tobacco material may be fermented, cured, uncured, toasted, or otherwise pre-treated. The tobacco material may be provided in the form of cut rag tobacco. The cut rag tobacco can have a cut width of at least 15 cuts per inch (about 5.9 cuts per cm, equivalent to a cut width of about 1.7 mm) for example. The cut rag tobacco can be formed from a mixture of forms of tobacco material, for instance a mixture of one or more of paper reconstituted tobacco, leaf tobacco, extruded tobacco and bandcast tobacco.

The precursor material which is dried to form the solid aerosol-generating material may comprise at least about 10 wt %, at least about 15 wt %, at least about 20 wt %, at least about 25 wt %, at least about 30 wt %, at least about 35 wt %, or at least about 40 wt % tobacco solids (calculated on a wet weight basis). Additionally or alternatively, the precursor material may comprise up to about 60 wt %, up to about 55 wt %, up to about 50 wt %, up to about 45 wt %, or up to about 40 wt % tobacco solids (calculated on a wet weight basis). In some embodiments, the precursor material comprises from about 20wt % to about 40 wt % tobacco solids (calculated on a wet weight basis).

In some embodiments, the precursor material comprises at least about 10 wt %, about 20 wt %, at least about 30 wt %, at least about 40 wt %, at least about 50 wt %, at least about 60 wt %, at least about 70 wt %, at least about 80 wt %, or at least about 90 wt % extract from a tobacco or other flavour- or active-substance containing plant material (calculated on a wet weight basis). Alternatively or additionally, precursor material may comprise up to about 99 wt %, up to about 90 wt %, up to about 80 wt %, up to about 70 wt % or up to about 60 wt % extract from tobacco or other flavour- or active-substance containing plant material (calculated on a wet weight basis). In some embodiments, the precursor material comprises around 50 wt % tobacco extract (calculated on a wet weight basis).

In some embodiments, the dried aerosol-generating material may comprise at least about 45 wt %, at least about 50 wt %, at least about 60 wt %, at least about 70 wt %, at least about 80 wt %, at least about 90 wt %, or at least about 95 wt % tobacco material or tobacco extract, or flavour- or active-substance containing plant material extract (calculated on a dry weight basis). In some embodiments, the dried aerosol-generating material may comprise about 60 to about 80 wt % tobacco extract (calculated on a dry weight basis).

In some embodiments, the dried aerosol-generating material may comprise from about 2 wt % to about 10 wt % of nicotine, or from about 3 to about 6 wt % of nicotine (calculated on a dry weight basis).

In some embodiments, the precursor material comprises around 50 v/v % tobacco extract. Where the precursor material comprises around 50 v/v % tobacco extract and the tobacco extract has a tobacco solid content of between about 55 and about 60 v/v %, the overall tobacco solid content of the precursor material is from about 27.5 to about 30 v/v %.

In some embodiments, the tobacco extract has a solids content of between about 40 and about 65 wt %, between about 45 and about 65 wt %, or between about 40 and about 60 wt % (calculated on a wet weight basis). In some embodiments, the water content of the tobacco extract is between about 35 wt % and about 65 wt %, or between about 35 and about 55 wt % (calculated on a wet weight basis). In some embodiments, the nicotine content of the tobacco extract is between about 1 wt % and about 5 wt % (calculated on a wet weight basis).

In some embodiments, the dried aerosol-generating material may comprise at least about 45 wt %, at least about 50 wt %, at least about 60 wt %, at least about 70 wt %, at least about 80 wt %, at least about 90 wt %, or at least about 95 wt % tobacco solids (calculated on a dry weight basis). Additionally or alternatively, the solid aerosol-generating material may comprise up to about 99 wt %, up to about 98 wt %, up to about 95 wt %, up to about 90 wt % or up to about 80 wt %. In some embodiments, the dried aerosol-generating material may comprise about 60 to about 80 wt % tobacco solids (calculated on a dry weight basis).

In some embodiments, the tobacco extract is an aqueous tobacco extract. In some embodiments, the tobacco extract may be concentrated and subsequently diluted before being added to the precursor material and dried. In other embodiments, the tobacco extract is not concentrated and may be used directly in the precursor material.

The precursor material may be in the form of a slurry, a suspension, a gel, a liquid or a solid, but in some embodiments which may be preferred, it is in the form of a suspension or liquid. In some embodiments, particles of solid material may be removed from the extract and/or from the precursor material by filtration and/or centrifugation. In some embodiments, the extract or precursor material may be filtered or centrifuged in order to remove particles above a particular size. Alternatively or additionally, the extract or precursor material may be ground to reduce the size of any particles present.

In some embodiments, it may be desirable for any particles in the precursor composition to have an average particle size of no greater than about 3 mm, of no greater than 1 mm, of no greater than about 0.5 mm, or to have an average particle size of no greater than about 0.3 mm, when measured by sieving or by observing the size of the particles by SEM. If necessary, the extract or precursor material may be processed to ensure that they do not include particles with a size greater than desired when measured by sieving.

The water content of the precursor material may be at least about 20 wt %, at least about 30 wt %, at least about 40 wt %, at least about 50 wt %, at least about 60 wt %, at least about 70 wt %, at least about 80 wt %, or at least about 90 wt % on a wet weight basis. Alternatively or additionally, the water content of the precursor material may be up to about 95 wt %, up to about 90 wt %, up to about 85 wt %, up to about 80 wt %, up to about 75 wt %, up to about 70 wt %, up to about 65 wt %, up to about 60 wt %, up to about 55 wt % or up to about 50 wt % on a wet weight basis. In some embodiments, the water content of the precursor material is between about 40 and about 50 wt % on a wet weight basis (50% and 60 v/v %). When the precursor material has a lower water content, the spray/freeze-drying process is quicker, as there is less water to remove.

In some embodiments, the solid aerosol-generating material and/or the precursor material comprises one or more active substance. This may be derived from the extract or it may be added. In some embodiments, the extract from a flavour- or active-substance containing plant material comprises an active substance.

The active substance may be a physiologically active material, which is a material intended to achieve or enhance a physiological response. The active substance may for example be selected from nutraceuticals, nootropics and psychoactives. The active substance may comprise, for example, nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

In some embodiments, the precursor material may comprise an extract from other botanical source(s) along with or instead of the tobacco extract.

As noted herein, the extract may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. The extract may comprise or be derived from botanicals in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v., Mentha spicata crispa, Mentha cardifolia, Mentha longifolia, Mentha suaveolens variegata, Mentha pulegium, Mentha spicata c.v. and Mentha suaveolens

In some embodiments, the extract comprises or is derived from one or more botanicals or constituents, derivatives or extracts thereof selected from eucalyptus, star anise, cocoa and hemp.

In some embodiments, the extract comprises or is derived from one or more botanicals or constituents, derivatives or extracts thereof selected from rooibos and fennel.

In some embodiments, the solid aerosol-generating material and/or the precursor material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The solid aerosol-generating material and/or the precursor material may comprise one or more cannabinoid compounds selected from the group consisting of cannabidiol (CBD) and THC (tetrahydrocannabinol).

The solid aerosol-generating material and/or the precursor material may comprise cannabidiol (CBD).

The solid aerosol-generating material and/or the precursor material may comprise nicotine and cannabidiol (CBD).

The solid aerosol-generating material and/or the precursor material may comprise nicotine, cannabidiol (CBD), and THC (tetrahydrocannabinol).

The solid aerosol-generating material further comprises an aerosol-former material. In some embodiments, this aerosol-former material is included in the precursor material.

In some embodiments, the precursor material comprises at least about 1 wt %, at least about 5 wt %, at least about 10 wt %, or at least about 20 wt % aerosol-former material (calculated on a wet weight basis). Additionally or alternatively, the precursor material may comprise up to about 40 wt %, up to about 35, up to about 30 wt %, up to about 25 wt %, up to about 20 wt %, or up to about 10 wt % aerosol-former material (calculated on a wet weight basis).

In embodiments of the invention in which the aerosol-former material is glycerol, the precursor material may comprise at most 36 wt % of glycerol. The inventors have demonstrated that dry weight inclusion levels up to 36 wt % (calculated on a dry weight basis) of aerosol-former material are possible.

The amount of glycerol in the precursor material, and therefore the solid aerosol-generating material, is important because it is both an aerosol-forming material and also a plasticizer. If the concentration of glycerol it too high, it may be detrimental to a critical temperature of the product during the freeze-drying process and may result in collapse of the product if the critical temperature of the formulation is exceeded.

As glycerol and some other aerosol-former materials are considered to have anti-freeze properties, it is particularly surprising that it is possible to freeze-dry a precursor material comprising such materials. Nevertheless, the inventors have discovered that precursor materials comprising glycerol may be freeze dried to form a highly useful aerosol-generating material.

In some embodiments, the solid aerosol-generating material may comprise at least about 1 wt %, at least about 5 wt %, at least about 10 wt %, at least about 20 wt %, at least about 30 wt %, or at least about 40 wt % aerosol-former material (calculated on a dry weight basis).

In some embodiments, the solid aerosol-generating material may comprise from about 1 to about 34 wt %, or from about 17 to about 34 wt % aerosol-former material (calculated on a dry weight basis). In some embodiments in which the aerosol-former material is glycerol, the dried aerosol-generating material may comprise from about 13 to about 34 wt % glycerol (calculated on a dry weight basis).

In embodiments in which Burley tobacco is used, the aerosol-generating material may comprise from about 17 to about 36 wt % of glycerol. The amount of glycerol in the aerosol material is important because it is both an aerosol-forming material and a plasticizer. If the concentration of glycerol is too high, it may be detrimental to the critical temperature of the product during the freeze-drying process and may result in collapse of the product if a critical temperature of the formulation is exceeded. On the other hand, sufficient glycerol should be included to provide the consumer with an adequate and pleasing aerosol.

In some embodiments, the solid aerosol-generating material and/or the precursor material further comprises one or more excipients. In some embodiments, the excipient stabilises and preserves the precursor material and the inventors have found the inclusion of an excipient especially important for stability when the precursor material comprised glycerol as the aerosol-forming material. The excipient may also act as a bulking agent or a filler material. In some embodiments, the inclusion of an excipient may also improve the handleability of the dried aerosol-generating material, helping it to retain its granular form by helping to reduce moisture uptake and the resulting increase in tackiness of the material. The presence of an excipient may also have an effect on the speed of (freeze) drying.

Suitable excipients include mannitol, sucrose, trehalose, lactose, sorbitol, raffinose, maltose, dextrans such as Dextran 10, Dextran 70, Dextran 90, maltodextrin, gelatin, agar, cyclodextrins, and polyethylene glycols such as PEG 2000-6000, and polyvinylpyrrolidone (PVP 10).

In some embodiments, the solid aerosol-generating material and/or the precursor material comprises one or more excipients in an amount of from o to about 40 wt % on a wet weight basis. In some embodiments, the precursor material may comprise at least about 1 wt %, at least about 10 wt %, at least about 20 wt %, or at least about 30 wt %, and/or up to about 40 wt %, up to about 30%, up to about 20 wt %, or up to about 10 wt % excipient on a wet weight basis.

In some embodiments, the solid aerosol-generating material may comprise at least about 0.1 wt %, at least about 10 wt %, at least about 20 wt %, or at least about 25 wt % excipient (calculated on a dry weight basis). In some embodiments, the solid aerosol-generating material may comprise up to about 25%, up to about 20 wt %, up to about 15 wt %, or up to about 10 wt % excipient (calculated on a dry weight basis).

In an exemplary embodiment, the solid aerosol-generating material comprises about 36wt % glycerol, about 45 wt % tobacco extract, and about 19 wt % excipient on a dry weight basis.

In another exemplary embodiment, the solid aerosol-generating material comprises from about 17 to about 39 wt % glycerol, from about 41 to about 76 wt % tobacco extract, and from o to about 28 wt % excipient on a dry weight basis.

In embodiments in which the excipient is agar, the precursor material may comprise o wt %, about 5 wt %, or about 10 wt % agar. The inventors have found that agar makes the precursor material more viscous and that the freeze-drying process is easier when the precursor material comprises a lower concentration of the agar excipient.

In some embodiments, the precursor material comprises about 50 wt % tobacco extract, from o to about 36 wt % aerosol forming agent (for example, from o to about 15 v/v %) and from o to about 40 wt % (for example, about 37.5 v/v %) excipient. The tobacco extract may comprise about 55 wt % tobacco solids and the overall tobacco solids content of the precursor material is about 27.5 wt %.

In some embodiments, the precursor material comprises about 50 wt % tobacco extract, up to about 36 wt % (for example, about 15 v/v %) glycerol and from o to about 40 wt % (for example, about 37.5 v/v %) excipient. The tobacco extract may comprise about 55 wt % tobacco solids and the overall tobacco solids content of the precursor material is about 27.5 wt %.

Some sample formulations of dried aerosol-generating materials formed from aqueous tobacco extracts are summarised in Table 1 below, with the amounts provided on a dry weight basis. These are theoretical values (before drying and inherent losses). Typically from about 80 to 89% of the glycerol is retained following the drying. Glycerol may be used as an aerosol-former material, but can be replaced or partially replaced with one or more other aerosol-former material such as those disclosed herein. The excipient used may be a dextran such as Dextran 70. Again, this may be replaced or partially replaced with alternative excipients, such as those disclosed herein.

TABLE 1

| Tobacco extract, | Aerosol-former | | |
|---|---|---|---|
| including nicotine (%) | material (%) | Excipient (%) | Nicotine (%) |
| 100 | 0 | 0 | 4.8-9.2 |
| 85-70 | 15-30 | 0 | 3.6-7.3 |
| 80-70 | 0 | 20-30 | 3.8-6.5 |
| 45-70 | 10-36 | 16-25 | 3-5 |

The percentage content of nicotine in the formulation will depend on the type of tobacco used, and the presence of other components, i.e. the aerosol-former and the excipient.

In some embodiments, the solid aerosol-generating material and/or the precursor material comprises one or more binders. In some embodiments the one or more binder is selected from the group consisting of: thermoreversible gelling agents, such as gelatin; starches; polysaccharides; pectins; celluloses; cellulose derivatives, such as carboxymethylcellulose; and alginates.

In some embodiments, the solid aerosol-generating material and/or the precursor material comprises one or more flavour-modifier, flavour or flavourant. This may be derived from the extract or it may be added. As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-₃.

In some embodiments, the solid aerosol-generating material and/or the precursor material comprises one or more other functional materials, which may comprise one or more of pH regulators, colouring agents, preservatives, fillers, stabilizers, and/or antioxidants.

In some embodiments, the solid aerosol-generating material and/or the precursor material contains a filler component. The filler component is generally a non-tobacco component, that is, a component that does not include ingredients originating from tobacco. In some embodiments, the precursor material comprises less than 60 wt % of a filler, such as from 1 wt % to 60 wt %, or 5 wt % to 50 wt %, or 5 wt % to 30 wt %, or 10 wt % to 20 wt % on a wet weight basis.

The filler, if present, may comprise one or more inorganic filler materials such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, hemp fibre, cellulose and cellulose derivatives.

In some embodiments, the solid aerosol-generating material is in the form of a gel. A gelling agent may be added to the aerosol-generating material, the precursor material or may be optionally omitted. The gelling agent may comprise one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

The solid aerosol-generating material and/or the precursor material may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid. In some embodiments, the acid is selected from one of lactic acid, benzoic acid and levulinic acid.

In other embodiments the acid may be an inorganic acid. In some of these embodiments the acid may be a mineral acid. In some such embodiments, the acid may be at least one of sulphuric acid, hydrochloric acid, boric acid and phosphoric acid.

The inclusion of an acid may be beneficial in embodiments in which the solid aerosol-generating material and/or the precursor material comprises nicotine. In such embodiments, the presence of an acid may stabilise dissolved species in the slurry from which the solid aerosol-generating material is formed. The presence of the acid may reduce or substantially prevent evaporation of nicotine during drying of the slurry, thereby reducing loss of nicotine during manufacturing.

In certain embodiments, the aerosol-generating material comprises a gelling agent comprising a cellulosic gelling agent and/or a non-cellulosic gelling agent, an active substance and an acid.

The solid aerosol-generating material may be in the form of particles, such as in the form of a powder. In some embodiments, the solid aerosol-generating material is in the form of particles with a maximum particle size of about 1 mm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, or a maximum particle size of 10 μm, when measured by sieving. In some embodiments, the solid aerosol-generating material is in the form of particles with a minimum particle size of about 5 μm, 10 μm, 15 μm, 20 μm, 25 μm, 30 μm, 35 μm, 40 μm, 45 μm, 50 μm, 60 μm, 70 μm, 80 μm, 90 μm, or a maximum particle size of 100 μm, when measured by sieving.

In some embodiments, the solid aerosol-generating material formed by freeze-or spray-drying and is then processed with other suitable steps as required and known to the person skilled in the art to provide the dried material in the desired form, for example in the form of particles of the desired size(s).

### Spray-Drying and Freeze-Drying

The drying methods used to dry the precursor material may be any suitable drying process, including freeze-drying or spray-drying processes. The drying process used must be compatible with the precursor material and the desired make-up of the solid aerosol-generating material. As it may be desirable for the solid aerosol-generating material to include active and/or flavour substances derived from the extract in the precursor material, it is important to select a drying method that will retain a sufficient amount of these components.

In small scale examples, the precursor material is freeze-dried using freeze-drying microscopy, for example using a Lyostat freeze-drying microscope.

In a spray-drying process, the precursor material is sprayed and rapidly dried using a hot gas. The use of spray drying provides several advantages to the present invention: the dry particle size can be controlled and may be consistent; tobacco or flavour extracts or materials are heat sensitive but can still be spray-dried at relatively high inlet temperatures; a short residence time in the spray-drying equipment is required; and minimal loss of flavour/volatiles. This makes the process adaptable to reduce loss of volatile compounds and maintain the desired flavour of the aerosol generating material.

Freeze-drying, also known as lyophilisation or cryodesiccation, is a process in which the precursor material is frozen, the temperature lowered and the water is removed via sublimation under reduced pressure conditions. Without wishing to be bound by any specific theory, it is believed that the low processing temperatures and rapid water loss via sublimation avoid changes in the aerosol-generating material's structure, appearance and characteristics. This process preserves the structure of the precursor material, and reduces the loss and decomposition of volatile flavour compounds.

The solid aerosol-generating material has a lower water content than the precursor material. The water content of the solid aerosol-generating material may be at most about 0.5 wt %, about 1 wt %, about 2%, about 5 wt %, about 10 wt %, or about 20 wt % (calculated on a wet weight basis). The water content of the dried aerosol-generating material may be reduced from the precursor material by at least about 50 wt %, about 60 wt %, about 70 wt %, about 80 wt %, about 90 wt %, about 95 wt %, about 98 wt %, or by about 100 wt %. In some embodiments the dried aerosol-generating material has a water content of less than about 5 wt %, less than about 4 wt %, less than about 3 wt %, less than about 2 wt % or less than about 1 wt % (calculated on a wet weight basis), as measured by gas chromatography-thermal conductivity detector (GC-TCD) or Karl Fischer measurement.

In an exemplary embodiment of the invention, the precursor material comprises Burley tobacco extract and a water content of 60 wt %. After the freeze-drying operation described herein, the dried aerosol generating material has a water content of 3 wt %.

A lower water content of the dried aerosol-generating material is associated with longer shelf-life and stability. However, very low water content may be associated be a brittle structure and a smaller particle size, as well as taking longer to process. The material is also very hygroscopic. If the water content of the dried aerosol-generating material is too high on the other hand, the desired increased stability may not be achieved. The dried aerosol-generating material may also not be as easy to handle with higher water content, with the material becoming sticky.

The inventors have found that when the precursor material comprises an excipient, the precursor material may be better suited to being dried via spray-drying (compared to a precursor material without an excipient). Without wishing to be bound by any particular theory, it is speculated that increasing the amount of the excipient in the precursor material raises the glass transition temperature to above 100° C. and this affects the physical properties of the material, making it more suitable for spray drying.

### Liquid Component

The liquid component of the aerosol-generating compositions forms the base of the printable compositions. As such the liquid component contributes to various important properties of the compositions, including the viscosity of the printable compositions and the drying behaviour.

In some embodiments, the liquid component comprises a liquid carrier component.

For example, this liquid carrier may be an oil, such as a vegetable oil. Soy oil may a suitable vegetable oil. The carrier gives the liquid component and the printable composition the desired viscosity. The oil may also help with “wettability” and may give the printable composition desired physical and chemical properties, including flow.

In some embodiments, the liquid component comprises one or more aerosol-former materials capable of forming an aerosol. The aerosol-former may be, for instance, a polyol aerosol generator or a non-polyol aerosol generator. It may be a solid or liquid at room temperature, but preferably is a liquid at room temperature.

In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

In some embodiments, the aerosol-former material comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate. In some embodiments, the aerosol-former material comprises one or more compounds selected from erythritol, propylene glycol, glycerol, vegetable glycerine (VG), triacetin, sorbitol and xylitol.

In some embodiments, the aerosol-former material comprises or consists of one or more selected from: glycerol, propylene glycol and vegetable glycerol.

In some embodiments, the liquid component comprises the one or more aerosol-former material in a total amount of from about 10% to about 100% by volume of the total liquid component. In some embodiments, the liquid component comprises up to about 95% by volume of an aerosol-former material based on the total volume of the liquid component, up to about 90%, up to about 80%, up to about 70%, up to about 60%, up to about 50%, up to about 40%, up to about 30%, up to about 20%, or up to about 10% by volume. Additionally or alternatively, the liquid component comprises at least about 20% by volume of an aerosol-former material based on the total volume of the liquid component, at least about 30%, at least about 40%, at least about 50%, at least about 60%, at least about 70%, at least about 80%, or at least about 90% by volume.

In some embodiments, the liquid component may comprise further components, such as flavours. For example, in some embodiments, the liquid component comprises propylene glycol and a flavour. The flavour may be any one of the flavours mentioned herein.

In some embodiments, the liquid component comprises a solvent. For example, the solvent may be selected to evaporate when the composition is printed to produce a dried aerosol-generating composition. Additionally or alternatively, the solvent enhances the dissolution of the dried aerosol-generating material.

In some embodiments, the solvent is one or more selected from the group consisting of: water; hydrocarbons such as pentane, hexane, heptane, isooctane, and mineral oil; aromatic compounds, such as benzene, toluene and xylene; monohydric alcohols, such as methyl, ethyl, propyl, and isopropyl alcohols; polyhydric alcohols, such as glycol and glycerol; ketones, such as acetone, methyl ethyl ketone, methyl isobutyl ketone, and cyclohexanone; esters, such as ethyl acetate, propyl acetate, butyl acetate, isobutyl acetate, and amyl acetate; and other organic substances, such as ethers including diethyl ether, isopropyl ether, and tetrahydrofuran.

In some embodiments, the liquid component may comprise a water component to dissolve the dried aerosol generating material. As the addition of water may have a negative effect on the stability and shelf-life of the composition, and it will also increase the amount of energy required to volatilise the liquid component, it may be desirable to keep the water content as low as possible. In some embodiments, the liquid component comprises up to about 5% by volume water based on the total volume of the liquid components, up to about 4%, up to about 3%, up to about 2.5%, up to about 2%, up to about 1.5%, or up to about 1% by volume water.

In some embodiments, the liquid component comprises the one or more solvent in a total amount of from about 1% to about 50% by volume of the total liquid component. In some embodiments, the liquid component comprises up to about 45% by volume of a solvent, up to about 40%, up to about 35%, up to about 30%, up to about 25%, up to about 20%, up to about 15%, or up to about 10% by volume. Additionally or alternatively, the liquid component comprises at least about 1% by volume of a solvent based on the total volume of the liquid component, at least about 5%, at least about 10%, at least about 15%, at least about 20%, or at least about 25%.

In some embodiments, the liquid component comprises a binder. For example, the binder may be one or more selected from the group consisting of: gelatin; starches; polysaccharides; pectins; celluloses; cellulose derivatives, such as carboxymethylcellulose; and alginates.

In some embodiments, the liquid component comprises the binder in an amount of from about 1 to about 50 wt % by weight of the total liquid component. In some embodiments, the liquid component comprises up to about 45 wt % of a binder, up to about 40 wt %, up to about 35 wt %, up to about 30 wt %, up to about 25 wt %, up to about 20 wt %, up to about 15 wt %, or up to about 10 wt %. Additionally or alternatively, the liquid component comprises at least about 1 wt % of a binder, at least about 5 wt %, at least about 10 wt %, at least about 15 wt %, at least about 20 wt %, or at least about 25 wt %.

### Ink Compositions

The printable aerosol-generating compositions are formed by combining the solid aerosol-generating material and the liquid component.

In some embodiments, the printable aerosol-generating composition comprises from about 10 to about 50 wt %, or from about 10 to about 30% of the solid aerosol-generating material (in solid form or in dissolved form) based on the total weight of the composition.

In some embodiments, the printable aerosol-generating composition comprises up to about 60 wt % of the solid aerosol-generating material (in solid form or in dissolved form), up to about 50 wt %, up to about 40 wt %, up to about 30 wt %, or up to about 20 wt % of the total weight of the printable aerosol-generating composition. Additionally or alternatively, the printable aerosol-generating composition comprises at least about 10 wt % of the solid aerosol-generating material (in solid form or in dissolved form), at least about 15 wt %, at least about 20 wt %, at least about 25 wt %, at least about 30 wt %, at least about 35 wt %, at least about 40 wt %, or at least about 50 wt % of the total weight of the printable aerosol-generating composition.

In some embodiments, the solid aerosol-generating material is not soluble in the liquid component and the printable composition is a suspension.

In other embodiments, the solid aerosol-generating material is at least partially soluble in the liquid component and the printable composition is a suspension or a solution.

Where the aim is to produce a solution, dissolution of the solid aerosol-generating material may be enhanced or accelerated by providing the solid aerosol-generating material in the form of fine particles. For example, the particles may have an average particle size of no greater than about 100 μm, of no greater than about 50 μm, of no greater than about 25 μm, or to have an average particle size of no greater than about 10 μm, when measured by sieving.

In some embodiments, an aerosol-generating composition which is a suspension may be filtered or centrifuged in order to remove particles above a particular size.

In order to provide the aerosol-generating composition in the form of a solution, it may be possible to select a liquid component with one or more components in which the solid aerosol-generating material is soluble. For example, as discussed above, the liquid component may comprise a solvent.

Alternatively or additionally, in order to provide the aerosol-generating composition in the form of a solution, it may be possible to formulate the solid aerosol-generating material to exclude any components that are not soluble in the liquid aerosol-generating material. In some embodiments, the solid aerosol-generating material does not include an excipient that is insoluble in the liquid aerosol-generating material. In some embodiments, the solid aerosol-generating material includes an excipient or other components that are readily soluble in the liquid aerosol-generating material of the aerosol-generating composition.

In order to provide the aerosol-generating composition in the form of a solution, it may be possible to formulate the solid aerosol-generating material to exclude any components that are not soluble in the liquid component.

### The Support

The printable compositions disclosed herein may be applied to or printed on a support to provide an aerosol-generating substrate. The support or a layer of the support may be formed of any material suitable for receiving and holding the printable composition.

The support may, for example, be or comprise one or more materials selected from the following: paper; card; paperboard; cardboard; reconstituted material such as reconstituted paper or reconstituted plant material; a plastics material, such as polylactic acid; a ceramic material; activated carbon; glass; a sintered material, such as sintered glass, metal(s), ceramics or plastics; a composite material; a plant-derived material; a fabric or fleece; a fibrous tow such as cellulose acetate tow; a metal, or a metal alloy.

Whilst the surface of the support may be smooth, in some embodiments, the surface is rough. This rough surface is irregular, uneven and not smooth. For example, the rough surface may include indentations, holes, channels, protrusions.

Surface roughness is a component of surface texture and it is generally quantified by the deviations in the direction of the normal vector of a real surface from its ideal form. The profile roughness parameters are included in BS EN ISO 4287:2000 British standard, which is identical to the ISO 4287:1997 standard. One test of surface smoothness (or roughness) is the Bekk smoothness which is measured by an air leak method in which a test surface is clamped between a flat glass plate and a circular metal head and air is drawn across the surface of the test piece under a partial vacuum. The rate of airflow is measured in ml/minute between the paper and the applicable standards are ISO 5627, Tappi T479 and DIN 53107.

Surface structure and roughness plays a key role in governing contact mechanics, that is to say the mechanical behaviour exhibited at an interface between two solid objects as they approach each other and transition from conditions of non-contact to full contact. Here, those two solid objects are the support and the dried printed aerosol-generating composition. In particular, adherence of the printed aerosol-generating composition to the support will be governed by roughness and the contact area between the two solid objects.

As a result, to maximise the contact area and thus the adhesion between the support surface and the printed aerosol-generating composition, it is desirable to match the size of any particles of the solid aerosol-generating material to the size of the irregularities of the support surface. Thus, a highly porous support structure can accommodate larger (and, to some extent, also smaller) particles whilst still providing the desired level of adhesion or entrapment. On the other hand, finer particle sizes will be required where the support surface bas small surface irregularities.

Therefore, a wide variety of types of rough support structures may be used in the present invention and, as the skilled person would recognise, the particle size of the solid aerosol-generating material must be selected to match the dimensions of the surface irregularities. In some embodiments, the particles may be smaller than the dimensions of the irregularity, such as a pore. This will allow the particle to sit within the irregularity, with large area of contact between the surfaces of the support and the particle, and/or physical protection of the particle from forces that might lead to its movement and removal from the support surface. In other embodiments, the particles may be larger than the dimensions of the irregularity, such as a pore. Preferably, the particle will still be able to sit partially within the irregularity, with sufficient area of contact between the surfaces of the support and some physical protection.

In some embodiments, the irregularities on the surface of the support have a diameter, width or dimension in the range from 0.1 μm to about 1 mm

In some embodiments, the average diameter, width or dimension of the surface irregularities of the support is at least about 10%, at least about 15%, at least about 20% or at least about 25% greater than the average diameter, width or dimension of the particles of aerosol-generating material. In some embodiments, the average diameter, width or dimension of the surface irregularities of the support is no more than about 100%, no more than about 90%, no more than about 75%, or no more than about 50% greater than the average diameter, width or dimension of the particles of aerosol-generating material.

In some embodiments, the rough surface of the support may enhance the adhesion of the aerosol-generating composition to the support, helping to anchor the composition to the support. In some embodiments, the particles in the printable aerosol-generating composition have a size that complements the support surface roughness to enhance adhesion. For example, the particles of the aerosol-generating material may sit within recesses on the surface of the support.

In some embodiments, the support comprises a material with an inherently rough or porous surface.

For example, the support or part thereof may be formed from a rough or porous paper material, such as tipping paper, porous plug wrap, cigarette paper or tea bag paper. The paper may be a porous paper, such as air-laid paper. When printable composition is applied to the surface of such a support, the dried composition may be located within the pores of the porous paper to provide good adhesion between the dried composition and the paper. In some embodiments, the support surface comprises a paper material, the paper optionally having a weight of from about 20 gsm to about 100 gsm.

In some embodiments, the support is a (dried) tobacco material, such as, tobacco leaf, lamina or stem material, or a reconstituted tobacco material. The printable composition may be applied directly onto the rough surface of such support material.

In some embodiments, the support comprises a fabric, fleece or fibrous material, such as a tow. Such support materials may inherently have a porous structure, with spaces between fibres. The printable composition may adhere to the surfaces of fibres in the material, and/or may occupy the gaps between the fibres.

In some embodiments, the support is a woven or non-woven fabric or fleece comprising a plurality of fibres. In some embodiments, the fleece or fabric is manufactured by a dry-laid process, an air-laid process, a wet-laid process, a spun melt process, a melt blown process or the like to entangle fibres or filaments into a web in a manner that does not involve weaving or knitting.

The fabrics may comprise fibres formed from materials including cellulose fibres, viscose fibres, regenerated cellulose fibres, wood fibres, cotton fibres, wool fibres, or other fleece forming polymers, such as polyglycolic acid fibres, polylactic acid fibres, polyhydroxyalkanoate fibres, polycaprolactone fibres, polybutylene succinate fibres, polybutylene succinate adipate fibres, and combinations thereof. In some embodiments, the fibres are thermostable and/or biodegradable.

In some embodiments, the support is a porous material, such as an open-cell reticulated foam or sintered structure. In some embodiments, the porous material comprises a ceramic material, activated carbon material, zeolites, silica, wood, cork or other naturally occurring materials with a porous surface. Once again, the printable composition may be applied to or printed directly onto the surface of the porous support material.

In other embodiments, the support comprises a material which does not have inherent roughness, but instead the surface has been treated or shaped to form the rough or porous surface.

In some embodiments, at least a portion of the support surface may be made rough by making a number of holes or indentations in the support or a layer of the support. In some embodiments, the holes or indentations may be made by penetrating or indenting the surface with a pin or series of pins.

In some embodiments, the surface of the support may be rough due to the presence of a plurality of protuberances. Protuberances are elements that protrude from the surface of the support. The protuberances may take many forms, including, for example, cylinders, cubes, pyramids and irregular shapes. It is not necessary for the protuberances to all be formed of the same shape. The protuberances may cover all or most of the surface of the support, or only part of the surface of the support. In one example, protuberances may be formed by adding additional material or removing some material from the surface of the support.

In some embodiments, a surface of the support is embossed to create the surface roughness. The support may be embossed by stamping the support or layer thereof with a mould to cause the surface to have a three-dimensional or raised effect on selected areas. Embossing is a simple and repeatable way of creating a rough surface. The surface may be embossed using various patterns, such as one or more of spirals, lines, squares, circles and/or rectangles.

In some embodiments, the surface may be made rough by including one or more ridges, folds, indents or raised sections. These features may be created, for example, by processes or techniques such as creping or corrugating.

In some examples, the support surface is made rough by having one or more score lines formed in the surface. The score lines may be formed by known processes such as running a cutting element over the surface of the support to provide one or more cuts or indents in the first surface of the support.

In some examples, the surface roughness of the support is provided by a combination of one or more of protuberances, embossments and score lines.

In some embodiments, the support consists of or comprises a heating material that comprises one or more materials selected from the group consisting of: an electrically-conductive material, a magnetic material, and a magnetic electrically-conductive material. In some embodiments, the heating material may comprise a metal or a metal alloy. In some embodiments, the heating material may comprise one or more materials selected from the group consisting of: aluminium, gold, iron, nickel, cobalt, conductive carbon, graphite, plain-carbon steel, stainless steel, ferritic stainless steel, copper, and bronze.

In some embodiments, the heating material may be heated by induction heating. Induction heating is a process in which an electrically-conductive object is heated by penetrating the object with a varying magnetic field. In some embodiments, the heating material may be heated by resistive heating. In such embodiments, the heating material is connected to a power supply. Other possible types of heating include infrared heating and microwave heating.

In some embodiments, the heating material comprises a rough or porous surface, or holes, for example, it may be in the form of a mesh, a fibrous mass or a perforated, embossed or scored sheet. In other embodiments, the heating material may have a smooth surface, for example, it may be in the form of a flat strip or ribbon, or a rod or cylinder.

In some embodiments, the printable aerosol-generating composition is applied to or printed on the support in a plurality of spaced areas of the surface of the support, forming discrete portions of aerosol generating material. These portions may each generate aerosol for a single puff or enough aerosol for a series of puffs. In some embodiments, the substrate may allow the portions of aerosol-generating material to be independently heated. In other embodiments, the portions may be heated together, but the aerosol-generating material may be formulated or provided in forms to generate different aerosols and/or may generate aerosols at different times or at different rates.

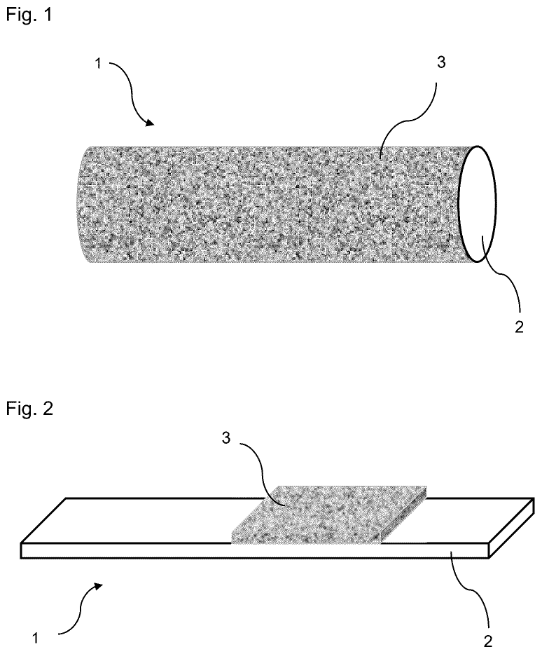

In FIG. 1, a substrate 1 is illustrated comprising a cylindrical support 2, the outer surface of which has been printed with an aerosol-generating composition that forms a layer or coating of aerosol-generating material 3, as discussed herein, bound to the surface of the support.

FIG. 2 illustrates an embodiment in which the substrate 1 comprises a flat support 2. A portion of one surface of the support 2 has been printed with aerosol-generating composition that forms a portion of aerosol-generating material 3 bound to the surface of the support 2.

In some embodiments, the support is a wrapper material, such as a paper wrapper. The aerosol-generating composition may be applied to at least a portion of a surface of the wrapper. In some embodiments, the composition may be used as an adhesive to secure the wrapper in place, or to hold the wrapper closed around the rod or aerosol-generating material.

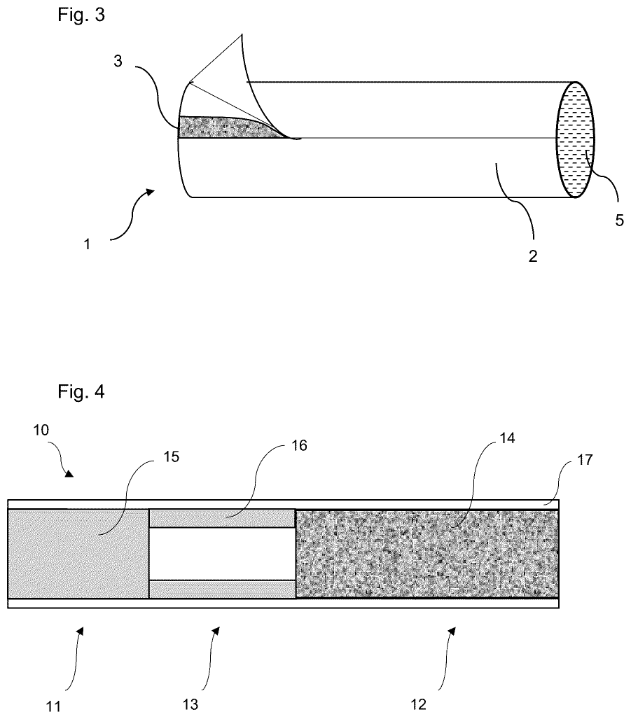

FIG. 3 illustrates such an embodiment, showing a substrate 1 comprising a support in the form of a paper wrapper 2 which is held in a rolled configuration by a printed strip or stripe of the aerosol-generating composition 3 as disclosed herein. In the embodiment shown, the wrapper 2 is wrapped around a section or plug of an additional aerosol-generating material 5.

In such an embodiment, there is an advantage that the aerosol-generating material can essentially be incorporated into material that would be included in the substrate or article anyway. This minimises the additional manufacturing complexity and cost. It also minimises the material that needs to be heated in addition to the aerosol-generating material in order to generate the aerosol, and so minimises the additional energy required.

In some embodiments, the support may be provided for the user to apply the printable aerosol-generating composition to, thus forming a substrate for use in an aerosol-provision system. In some embodiments, the support is reusable, so that the user can apply a predetermined amount or dose of an aerosol-generating composition to form a substrate, use the substrate, and then apply another predetermined amount or dose of an aerosol-generating composition to form a “recharged” substrate for use.

An accurate amount of the printable aerosol-generating composition may be applied to a support by use of a metering dispensing device that may, in some embodiments, measure the amount of aerosol-generating material and print it onto a substrate.

In some embodiments, the printable aerosol-generating composition may be applied to a support using a printing process, such as a process selected from the group consisting of: gravure printing, screen printing, lithography, relief printing and digital printing.

In some embodiments, the printable aerosol-generating composition may be applied using a stamp to transfer the composition from a reservoir to the surface of a support to form a substrate.

### Use of the Substrates

The substrates comprising the aerosol-generating composition and support may be used in combustible or non-combustible aerosol provision systems, or in an aerosol-free delivery system.

The present invention also relates to a consumable or article, comprising a composition comprising an extract from a flavour- and/or active-containing plant material and an aerosol-former material printed on a support.

In some embodiments, the substrate is provided in a consumable. Alternatively, the substrate may be used as a consumable.

A consumable is an article comprising aerosol-generating material, part or all of which is intended to be consumed during use by a user. In this case, the aerosol-generating material, or at least some of the aerosol-generating material, is provided as part of a substrate as disclosed herein, comprising the aerosol-generating material and a support.

A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor. As mentioned above, at least some of these components of a consumable may also be components of the substrate described herein.

The consumable may be any shape or size that is appropriate to the aerosol-generating device. In some embodiments, the consumable is a rod shape. In other embodiments, it may take the form of a flat strip, a tube, or a flexible sleeve.

In some embodiments, the substrate comprising an aerosol-generating material and a support is provided in an aerosol-generating device such as a tobacco-heating product (THP) or hybrid e-cigarette product. Advantageously, the substrate may be directly heated without burning to provide an inhalable aerosol. In some embodiments, heating the substrate will first cause the coating to decompose, to breach the barrier it forms around the aerosol-generating material. Then, the aerosolised components of the aerosol-generating material, for example the glycerol, nicotine and/or tobacco flavour will be released.

In some embodiments, the substrate comprising an aerosol-generating material and a support may be incorporated into the consumable in the absence of any other carrier or other material that would need to be heated.

The printable aerosol-generating composition may be applied to any part of a substrate or consumable. For example, the composition may be printed on a wrapper, plug wrap or tipping paper, or printed on a surface of a cooling section tube or on a surface of a filter plug.

The printable aerosol-generating composition may be applied to a surface of heating material, such as a susceptor.

The printable nature of the aerosol-generating compositions means that printed patches can provide accurate “dosing” of the composition and accurate positioning, to control how and when the composition is heated, and how much of the composition is heated. This means that accurate puff-by puff delivery of active and/flavour may be achieved.

In some embodiment, a consumable and/or an aerosol-generating system may include sufficient aerosol-generating composition to generate at least 100 puffs, at least 200 puffs, at least 300 puffs, at least 400 puffs, at least 500 puffs, at least 600 puffs, at least 700 puffs, at least 800 puffs, at least 900 puffs, or at least 1000 puffs.

### Delivery Systems

The delivery systems described herein can be combustible aerosol provision systems, non-combustible aerosol provision systems or an aerosol-free delivery systems.

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “combustible” aerosol provision system is one where a constituent aerosol-generating material of the aerosol provision system (or component thereof) is combusted or burned during use in order to facilitate delivery of at least one substance to a user.

In some embodiments, the delivery system is a combustible aerosol provision system, such as a system selected from the group consisting of a cigarette, a cigarillo and a cigar.

In some embodiments, the disclosure relates to a component for use in a combustible aerosol provision system, such as a filter, a filter rod, a filter segment, a tobacco rod, a spill, an aerosol-modifying agent release component such as a capsule, a thread, or a bead, or a paper such as a plug wrap, a tipping paper or a cigarette paper.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated and may be an aerosol-generating material provided on a support. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising a substrate comprising an aerosol-generating material and a support and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to a substrate comprising an aerosol-generating material and a support or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise a substrate comprising an aerosol-generating material and a support, an aerosol-generating material storage area, an aerosol-generating material transfer component, an aerosol generator, an aerosol generation area, a housing, a wrapper, a filter, a mouthpiece, and/or an aerosol-modifying agent.

FIG. 4 is a side-on cross-sectional view of a consumable or article 10 for use in an aerosol delivery system. The article 10 comprises a mouthpiece segment 11, and an aerosol generating segment 12.

The aerosol generating segment 12 is in the form of a cylindrical rod and comprises a substrate 14 comprising an aerosol-generating composition on a support. The substrate 14 can be any of the substrates comprising a printable aerosol-generating composition and a support discussed herein, such as the embodiment illustrated in FIG. 1.

In an alternative embodiment, the aerosol-generating segment may comprise a rod of aerosol-generating material, such as tobacco material, circumscribed by wrapper which has an aerosol-generating composition printed on it, for example as shown in FIG. 3.

Although described above in rod form, the aerosol-generating segment 12 can be provided in other forms.

The mouthpiece segment 11 in the illustrated embodiment includes a body of material 15 such as a plug of fibrous or filamentary tow. Between the aerosol generating segment 12 and the mouthpiece segment 11, there is positioned a cooling section 13 comprising a hollow tube 16 formed from a suitable material such as cellulose acetate, paper or a heat absorbing material.

The consumable 10 further comprises a wrapper 17, such as a paper wrapper, circumscribing the mouthpiece segment 11, the cooling section 13 and the aerosol generating segment 12.

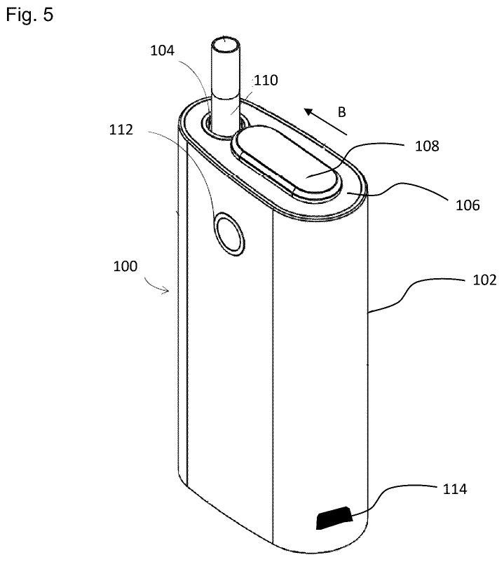

FIG. 5 shows an example of a non-combustible aerosol provision device 100 for generating aerosol from an aerosol-generating medium/material such as the composition of a consumable 110, as described herein. In broad outline, the device 100 may be used to heat a replaceable article 110 comprising the aerosol-generating medium, for instance an article 10 as illustrated in FIG. 4 or as described elsewhere herein, to generate an aerosol or other inhalable medium which is inhaled by a user of the device 100. The device 100 and replaceable article 110 together form a system.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 5, the lid 108 is shown in an open configuration, however the lid 108 may move into a closed configuration. For example, a user may cause the lid 108 to slide in the direction of arrow “B”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

In some embodiments, the substance to be delivered may be the aerosol-generating material of a substrate as described herein, and optionally another aerosol-generating material that may or may not be heated. As appropriate, the substrate and other aerosol-generating material may comprise one or more active constituents, one or more flavours, one or more aerosol-former materials, and/or one or more other functional materials.

### Stability

The invention enjoys the advantage of longer shelf life than other tobacco extracts.

The nicotine content of the precursor and solid aerosol-generating material after the freeze drying process has been calculated, providing an indication of the amount of nicotine retained following the processing. Compared to the original tobacco extract, the nicotine recovery of the dried aerosol generating material is at least about 76 wt % on a dry weight basis. The nicotine recovery of the dried aerosol generating material compared to the original tobacco extract may be at least about 60%, at least about 70%, at least about 75%, at least about 80%, or at least about 90% on a dry weight basis.

The glycerol content of the precursor and dried aerosol-generating material after the freeze drying process has been calculated, providing an indication of the amount of glycerol retained following the processing. Compared to the precursor material, the glycerol recovery of the dried aerosol generating material is at least about 85%. The glycerol recovery of the dried aerosol generating material compared to the precursor material may be at least about 70%, at least about 75%, at least about 80%, at least about 85%, at least about 90% at least about 95% on a dry weight basis.

### Example 1

In a first test, the precursor material comprised essentially of aqueous tobacco extract, and glycerol. The aqueous tobacco extract was diluted further with glycerol up to about 24 wt % (calculated on a dry weight basis). The Burley aqueous tobacco extract had a tobacco solid content of about 40 wt %, and a water content of about 60 wt %. The precursor material was dried via freeze drying.

### Example 2

In a further test, the precursor material comprised essentially of aqueous tobacco extract, glycerol and Dextran 70. The glycerol content was about o to about 15 v/v %, or up to about 36 wt % calculated on a dry weight basis. The precursor material was dried via freeze drying.

### Example 3

The freeze-dried material of Example 1 or Example 2 is ground to provide a loose powder with an average size of from about 10 μm to about 50 μm. 50 mg of the powder is then added to 2 ml of a liquid component comprising 50% vegetable glycerol and 50% propylene glycol by. This printable aerosol-generating composition is printed on to a paper support and used in a vapour device to provide approximately 500 puffs.

### Example 4

The freeze-dried material of Example 1 or Example 2 is ground to provide a loose powder with an average size of from about 10 μm to about 50 μm. 20 mg of the powder is then added to 1 ml of a liquid component comprising 60% propylene glycol, 35% vegetable glycerol and 5% water by volume. This printable composition forms a solution with no particulate matter and is applied to a metal strip susceptor to be used in a vapour device to provide at least 200 puffs.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol-generating composition for printing, the composition comprising a solid aerosol-generating material comprising a dried extract from a flavour- and/or active-containing plant material and an aerosol-former material, wherein the solid aerosol-generating material is suspended or dissolved in a liquid component.

2. An aerosol-generating composition as claimed in claim 1, wherein the liquid component comprises a solvent that evaporates to produce a dried aerosol-generating composition.

3. An aerosol-generating composition as claimed in claim 2, wherein the solvent is one or more selected from the group consisting of: water; hydrocarbons; aromatic compounds;
monohydric alcohols; polyhydric alcohols; ketones; esters; and ethers.

4. An aerosol-generating composition as claimed in claim 2, wherein the liquid component comprises the solvent in an amount of from about 1 to about 50% by volume of the total liquid component.

5. An aerosol-generating composition as claimed in claim 1, wherein the liquid component comprises a binder.

6. An aerosol-generating composition as claimed in claim 5, wherein the binder is one or more selected from the group consisting of: gelatin; starches; polysaccharides; pectins;
celluloses; cellulose derivatives; and alginates.

7. An aerosol-generating composition as claimed in claim 5, wherein the liquid component comprises the binder in an amount of from about 1 to about 50 wt % by weight of the total liquid component.

8. An aerosol-generating composition as claimed in claim 1, comprising from about 10 to about 50 wt % solid aerosol-generating material based on the total weight of the composition.

9. An aerosol-generating composition as claimed in claim 1, wherein the aerosol-former material is selected from the group consisting of: glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

10. An aerosol-generating composition as claimed in claim 1, wherein the solid aerosol-generating material is formed by drying a precursor composition comprising an extract from a flavour- and/or active-containing plant material.

11. An aerosol-generating composition as claimed in claim 10, wherein the precursor material is dried to a moisture content of from 0 to about 5% (calculated on a wet weight basis).

12. An aerosol-generating composition as claimed in claim 10, the precursor material comprising from about 10 to 95% by weight of the extract from a flavour- or active-containing plant material.

13. An aerosol-generating composition as claimed in claim 10, wherein the precursor composition comprises one or more aerosol-former material.

14. An aerosol-generating composition as claimed in claim 13, the precursor material comprising from about 1 to about 36 wt % aerosol-former material.

15. An aerosol-generating composition as claimed in claim 10, the precursor material comprising from 0 to about 40% by weight of an excipient.

16. An aerosol-generating composition as claimed in claim 15, wherein the excipient is one or more selected from the group consisting of include mannitol, sucrose, trehalose, lactose, sorbitol, raffinose, maltose, Dextran 10, Dextran 70, Dextran 90, maltodextrin, gelatin, agar, cyclodextrin, PEG 2000-6000, and PVP 10.

17. An aerosol-generating composition as claimed in claim 10, the precursor material comprising a liquid suspension comprising particles with an average particle size of no greater than about 1 mm, when measured by sieving.

18. An aerosol-generating composition as claimed in claim 1, wherein the plant material is selected from the group consisting of tobacco, eucalyptus, star anise, cocoa and hemp.

19. An aerosol-generating composition as claimed in claim 1, wherein the extract from a flavour- or active-containing plant material is an aqueous extract.

20. An aerosol-generating composition as claimed in claim 1, wherein the extract from a flavour- or active-containing plant material is an aqueous tobacco extract.

21. An aerosol-generating composition as claimed in claim 1, wherein the solid aerosol-generating material comprises from about 40 to about 99% by weight tobacco solids.

22. An aerosol-generating composition as claimed in claim 1, wherein the solid aerosol-generating material is in the form of particles with a maximum particle size of about 1 mm, when measured by sieving

23. A substrate for use in a non-combustible aerosol-provision system, comprising an aerosol-generating composition as claimed in claim 1 printed on a support.

24. A substrate as claimed in claim 23, wherein the support comprises one or more selected from the group consisting of: paper, card, paperboard, cardboard, reconstituted material, a plastics material, activated carbon, glass, a sintered material, a ceramic material, a composite material, a plant-derived material, a fabric or fleece, a fibrous tow, a metal, and a metal alloy.

25. A substrate as claimed in claim 23, wherein the support comprises a heating material.

26. A substrate as claimed in claim 23, wherein the aerosol-generating composition covers at least a portion of a surface of the support.

27. A substrate as claimed in claim 23, wherein a plurality of discrete portions of the aerosol-generating composition are provided on the support.

28. An aerosol-generating composition as claimed in claim 1 for use in an aerosol provision system.

29. An article comprising a composition comprising an extract from a flavour- and/or active-containing plant material and an aerosol-former material printed on a support.

30. An article, comprising a substrate as claimed in claim 23.

31. A non-combustible aerosol-provision system comprising an aerosol-generating composition as claimed in claim 1.

32. A method of providing an aerosol-generating composition for printing comprising:
drying a precursor material comprising an extract from a flavour- and/or active-containing plant material to form a solid aerosol-generating material; and
suspending or dissolving the solid aerosol-generating material in a liquid component.

33. A method as claimed in claim 32, further comprising adjusting the particle size of the solid aerosol-generating material to a maximum size of about 1 mm, when measured by sieving.

34. A method as claimed in claim 32, further comprising adjusting the particle size of any solid material in the precursor material to a maximum size of about 1 mm, when measured by sieving.

35. A method as claimed in claim 32, wherein the precursor material is dried by spray-drying or freeze-drying.

36. A method for providing a substrate comprising:
contacting a support with an aerosol-generating composition as claimed in claim 1; and
drying the aerosol-generating composition to form a coating of an aerosol generating material on the support.

37. A method as claimed in claim 36, wherein the aerosol-generating composition is applied by a printing process.

38. A method as claimed in claim 37, wherein the printing process is selected from the group consisting of: gravure printing, screen printing, lithography, relief printing and digital printing.
